(19) United States
(12) Patent Application Publication
(10) Pub. No.: US 2010/0098513 A1
(43) Pub. Date: Apr. 22, 2010

(54) SELF-LOCKING FASTENER AND METHOD FOR MOUNTING THE SAME

(75) Inventor: TIEN-MING WANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/334,541

(22) Filed: Dec. 15, 2008

(30) Foreign Application Priority Data
Oct. 17, 2008 (CN) 200810304985.1

(51) Int. Cl. F16B 33/02; F16B 39/28

(52) U.S. Cl. 411/343; 411/263

(57) ABSTRACT

A self-locking fastener includes a head, and a solid shaft extending from the head. The shaft includes a threaded portion away from the head. A slot is defined in the threaded portion along the axis of the threaded portion to divide the threaded portion into two parts.

### BACKGROUND

1. Technical Field

The present disclosure relates to fasteners and, specifically, to a self-locking fastener and a method for mounting the fastener.

2. Description of Related Art

In many devices, to keep a fastener, such as a screw or bolt, from backing out of a threaded hole due to vibration, a nut or similar device is often used, which adds time to assembly and is not cost-effective.

### BRIEF DESCRIPTION OF THE DRAWINGS

FIG. 1 is an isometric view of a first embodiment of a self-locking fastener.

FIG. 2 is an assembled view of the self-locking fastener of FIG. 1 together with an object.

FIG. 3 is a cross-sectional view taken along the line III-III of FIG. 2.

FIG. 4 is an isometric view of a second embodiment of a self-locking fastener.

FIG. 5 is an isometric view of a third embodiment of a self-locking fastener.

### DETAILED DESCRIPTION

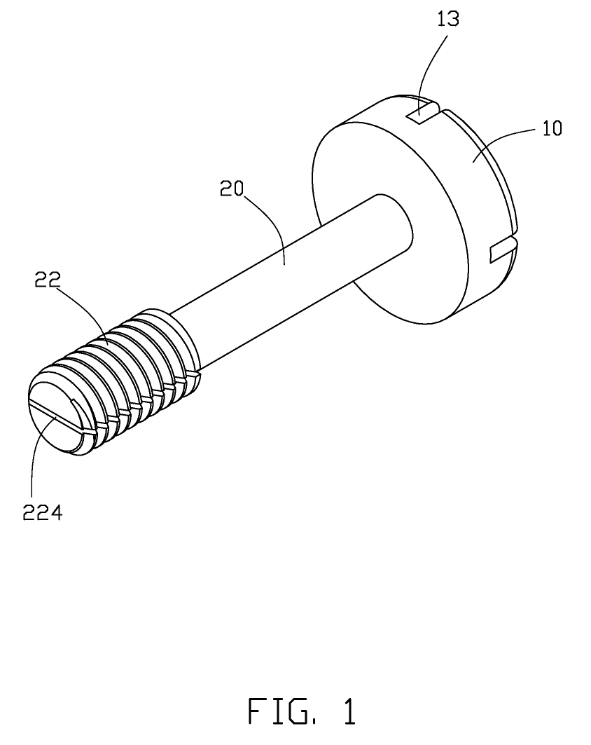

Referring to FIG. 1, a first embodiment of a self-locking fastener includes a head 10, and a solid shaft 20 extending from the head 10. A top portion of the head 10 defines a drive means such as a recess 13. A threaded portion 22 is formed on a section of the shaft 20 away from the head 10. A straight slot 224 is defined in the threaded portion 22 along the axis of the threaded portion 22, thereby the threaded portion 22 is bisected along the axis of the threaded portion 22 to form two parts. The area of a cross section of the threaded portion 22 is greater than that of a middle section of the shaft 20 in the shank between the threaded portion 22 and the head 10.

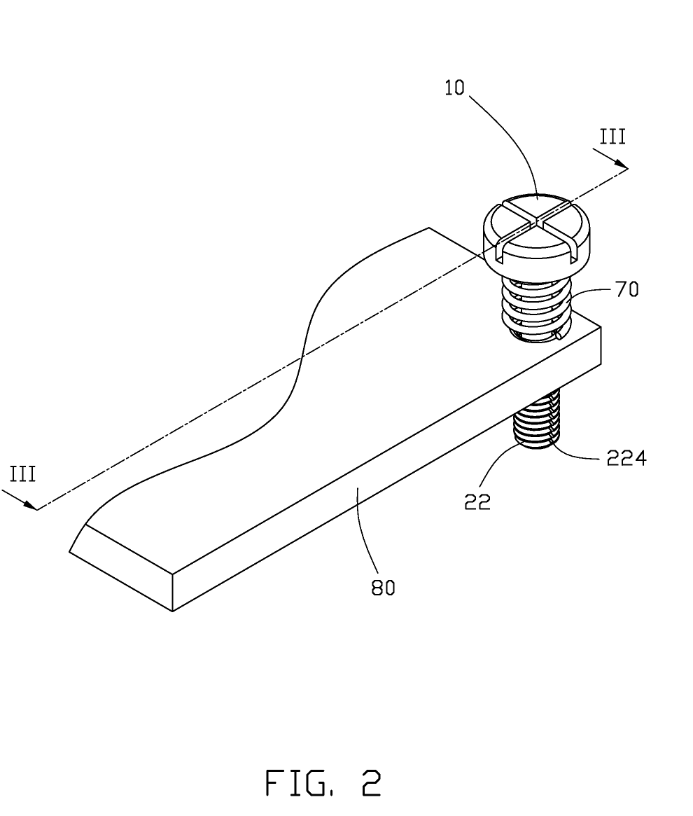

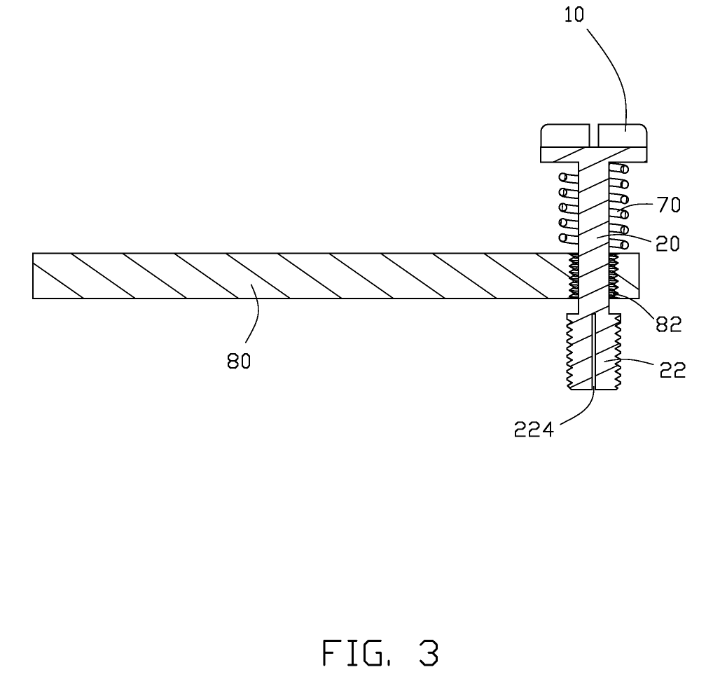

Referring to FIGS. 2 and 3, to assemble the fastener to an object 80, a compression spring 70 is placed around the shank of the shaft 20. The threaded portion 22 is compressed for inserting the threaded portion 22 into a threaded hole 82, whose diameter is slightly less than the threaded portion 22 before compression. A driver (not shown) is operated to engage with the recess 13 of the head 10 and rotatingly drive the fastener into the threaded hole 82, until the threaded portion 22 passes through the threaded hole 82. The threaded portion 22 decompresses to its free-state diameter. The compression spring 70 is compressed and acts as a shock absorber to dampen vibrations. Because the threaded portion 22 is restored to its free-state diameter, the threads of threaded portion 22 nearest the head 10 engage with the edge of the threaded hole 82, thereby the fastener is fixed to the object 80 and will not back out of the threaded hole 82 due to vibrations during transport or use.

To detach the fastener from the object 80, the parts of the threaded portion 22 are compressed toward each other to make the threaded portion 22 fit the threaded hole 82. The fastener is then rotated to disengage the threaded portion 22 from the threaded hole 82.

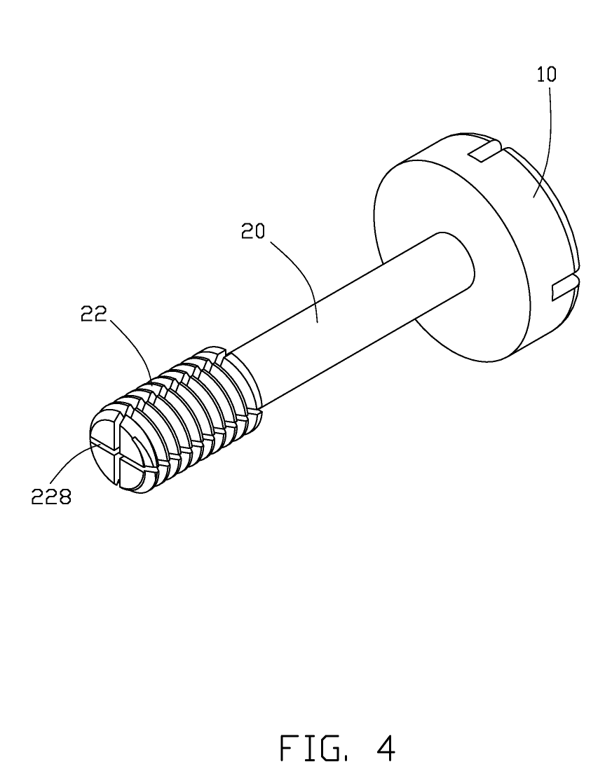

Referring to FIG. 4, a second embodiment of a self-locking fastener is provided. An additional slot is added perpendicular to the straight slot 224 of the threaded portion 22 of the fastener of the first embodiment to form a cruciform slot 228. The cruciform slot 228 extends through the threaded portion 22 along the axis of the threaded portion 22 to divide the threaded portion 22 into four parts.

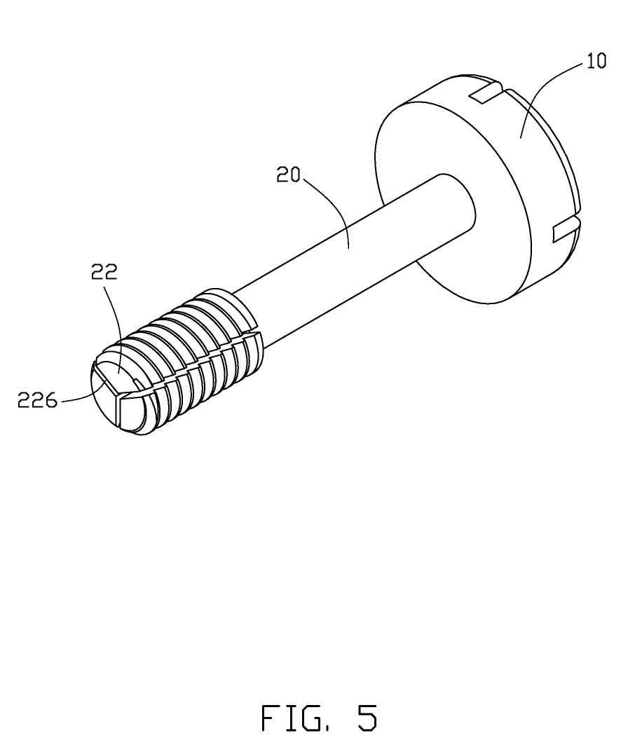

Referring to FIG. 5, a third embodiment of a self-locking fastener is provided. The straight slot 224 of the threaded portion 22 of the fastener of the first embodiment is replaced by a Y-shaped slot 226. The Y-shaped slot 228 extends through the threaded portion 22 along the axis of the threaded portion 22 to divide the threaded portion 22 into three parts.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the disclosure.

What is claimed is:

1. A self-locking fastener comprising:
a head; and
a solid shaft extending from the head, wherein the shaft comprises a threaded portion away from the head, wherein a slot is defined in the threaded portion along the axis of the threaded portion to divide the threaded portion into at least two parts.

2. The self-locking fastener of claim 1, wherein the slot is a straight slot, to divide the threaded portion into two parts.

3. The self-locking fastener of claim 1, wherein the slot is a cruciform slot, to divide the threaded portion into four parts.

4. The self-locking fastener of claim 1, wherein the slot is a Y-shaped slot, to divide the threaded portion into three parts.

5. The self-locking fastener of claim 1, wherein the slot extends through the threaded portion across the axis of the threaded portion.

6. The self-locking fastener of claim 1, wherein the shaft further comprises a middle section connected between the head and the threaded portion, and the outer diameter of the threaded portion is larger than a diameter of the middle portion.

7. A method for mounting a fastener to an object that defines a threaded hole, comprising:
providing said fastener comprising a head, and a solid shaft extending from the head, wherein the shaft comprises a threaded portion away from the head and an unthreaded portion, wherein a slot is defined in the threaded portion along the axis of the threaded portion, to divide the threaded portion into at least two parts;
shrinking the at least two parts of the threaded portion toward the slot and inserting the shrunk threaded portion into the threaded hole of the object;
rotating the fastener to engaging the threaded portion in the threaded hole until the threaded portion passes through the threaded hole, whereby the at least two parts of the threaded portion restored to splay and engaging with a portion of the object bounding the threaded hole.

8. The method of claim 7, further comprising providing a compression spring placed around the unthreaded portion of the shaft of the fastener, wherein when the threaded portion passes through the threaded hole, the compression spring is compressed and sandwiched between the head and the object.

9. The method of claim 7, wherein the slot is a straight slot to divide the threaded portion into two parts.

10. The method of claim 7, wherein the slot is a cruciform slot to divide the threaded portion into four parts.

11. The method of claim 7, wherein the slot is a Y-shaped slot to divide the threaded portion into three parts.

12. The method of claim 7, wherein the slot extends through the threaded portion along the axis of the threaded portion.

13. The method of claim 7, wherein the shaft comprises a middle section connected between the head and the threaded portion, and the area of a cross section of the threaded portion is greater than the area of a cross section of the middle section.

14. The method of claim 7, wherein the outer diameter of the threaded hole of the object is slightly less than the diameter of the threaded portion before compression.

15. A self-locking fastener comprising:
a head; and
a solid shaft comprising an unthreaded portion extending from the head and a threaded portion extending from the unthreaded portion, the outer diameter of the threaded portion is larger than a diameter of the unthreaded portion, wherein a slot is defined in the threaded portion along the axis of the threaded portion to divide the threaded portion into at least two parts.

16. The fastener of claim 15, further comprising a spring capable of being sleeved on the unthreaded portion.

17. The fastener of claim 15, wherein the head defines a fastening-facilitating structure.

18. The fastener of claim 15, wherein the slot is a cruciform slot, to divide the threaded portion into four parts.

19. The fastener of claim 15, wherein the slot is a Y-shaped slot, to divide the threaded portion into three parts.
